(19) United States
(12) Patent Application Publication
(10) Pub. No.: US 2008/0235382 A1
(43) Pub. Date: Sep. 25, 2008

(54) FAULT TOLERANT TCP SPLICE SYSTEMS AND METHODS

(75) Inventors: Manish MARWAH, Mountain View, CA (US); Christof FETZER, Dresden (DE); Shivakant MISHRA, Superior, CO (US)

Correspondence Address: LATHROP & GAGE LC, 4845 PEARL EAST CIRCLE, SUITE 300, BOULDER, CO, 80301, US

(73) Assignee: THE REGENTS OF THE UNIVERSITY OF COLORADO, Denver, CO (US)

(21) Appl. No.: 12/018,115

(22) Filed: Jan. 22, 2008

Related U.S. Application Data
(60) Provisional application No. 60/881,670, filed on Jan. 22, 2007.

(51) Int. Cl. G06F 15/16

(52) U.S. Cl. 709/228

(57) ABSTRACT

Computer architecture and method splice a new TCP connection. A proxy group for the new TCP connection is determined and, at one of the proxies, the new TCP connection is accepted. At the one proxy, a client request is received from a client of the new TCP connection and an appropriate backend server to handle the client request is determined. At the one proxy, the client request is spliced and sent to the appropriate backend server. Splicing state information of the new TCP connection is sent from the one proxy to other proxies of the proxy group. Each subsequent TCP segment of the new TCP connection is spliced and sent to the appropriate backend server at any one proxy of the proxy group.

### RELATED APPLICATIONS

This application claims priority to U.S. Provisional Application Ser. No. 60/881,670, filed Jan. 22, 2007, which is incorporated herein by reference.

### BACKGROUND

Internet services are commonly offered over the web using application layer proxies. These proxies perform a number of important functions, including layer-7 or content-based routing that routes different client requests to the appropriate application servers based on request content. Other functions performed by these proxies include web content caching, implementation of security policies (e.g., authentication, access control lists), implementation of network management policies (e.g., traffic shaping) and usage accounting.

TCP splicing has been commonly used for improving the performance of serving web content through proxies. It avoids any context switches or data copying between kernel and user space, resulting in improved performance. It has been shown that TCP splicing makes the performance of a proxy comparable to that of IP forwarding. Advantages of using TCP splicing to build web servers are described in “An Evaluation of TCP Splice Benefits in Web Proxy Servers” by Marcel-Catalin Rosu and Daniela Rosu: International WWW Conference in Honolulu, Hi., USA (2002).

At present, TCP splicing based web server architectures suffer from two drawbacks: (1) traffic between clients and servers (both directions) must pass through a proxy, thus making the proxy scalability and performance bottlenecks; and (2) the architectures are not fault tolerant. If a proxy fails, clients have to re-establish their HTTP connections and re-issue failed requests, even in the presence of a backup proxy.

### SUMMARY OF THE INVENTION

Three enhancements to the TCP splicing mechanism are now described: (1) Enabling a TCP connection to be simultaneously spliced through multiple machines for higher scalability; (2) Making a spliced connection fault-tolerant to proxy/web switch failures; and (3) Providing flexible splitting of a TCP splice between a proxy/web switch and a backend server to increase scalability of a web server system. These enhancements to the TCP splice mechanism can be used wherever TCP splice is used.

A web server architecture based on the enhanced TCP splicing is also described. This architecture provides a scalable, seamless service to the users with minimal disruption during proxy (web server) failures. In addition to traditional web services in which users download web pages, multimedia files and other types of data from a web server, this architecture supports emerging web services that are highly interactive, and involve relatively longer, stateful client-server sessions.

In an embodiment, a method splices a new TCP connection. A proxy group for the new TCP connection is determined and, at one of the proxies, the new TCP connection is accepted. At the one proxy, a client request is received from a client of the new TCP connection and an appropriate backend server to handle the client request is determined. At the one proxy, the client request is spliced and sent to the appropriate backend server. Splicing state information of the new TCP connection is sent from the one proxy to other proxies of the proxy group. Each subsequent TCP segment of the new TCP connection is spliced and sent to the appropriate backend server at any one proxy of the proxy group.

In an embodiment, a fault-tolerant TCP splice method includes the steps of: determining a proxy group for each new TCP connection; distributing a first TCP segment of the new TCP connection to proxies of the proxy group; at one of the proxies, accepting the new TCP connection; receiving a client request at the one proxy and determining an appropriate backend server to receive the client request; splicing, at the one proxy, the client request to the appropriate backend server; sending the client request to the appropriate backend server from the one proxy; and sending splicing state information of the spliced TCP connection to all other proxies of the proxy group.

In an embodiment, a fault-tolerant TCP splice method receives, at a load balancer, a TCP segment from a client. The TCP segment is distributed to a first proxy. The first proxy determines whether the TCP segment is a new client TCP connection and splices and sends the TCP segment to a previously determined backend server if the TCP segment is not a new TCP connection. If the TCP segment is a new TCP connection, a proxy group for splicing the TCP connection is determined and the TCP segment is distributed to all members of the proxy group. The TCP connection from the client is accepted at one proxy of the proxy group. A client request is received at the one proxy and an appropriate backend server to receive the client request is determined. The client request is spliced to the appropriate backend server at the one proxy and the client request is sent to the appropriate backend server from the one proxy. Splicing state information of the spliced TCP connection is sent to all other proxies of the proxy group.

In an embodiment, computer architecture has fault-tolerant TCP splicing. The computer architecture includes at least one backend server and, for each new TCP connection, a proxy group selected from a plurality of proxies. One proxy of the proxy group accepts the new TCP connection and receives a client request from a client associated with the new TCP connection. The one proxy splices and sends the client request to an appropriate one of the at least one backend servers. The one proxy sends splicing state information of the new TCP connection to other proxies of the proxy group.

### BRIEF DESCRIPTION OF THE FIGURES

FIG. 1 shows one system embodiment with fault-tolerant TCP splicing.

FIG. 2 shows a flowchart illustrating one exemplary method embodiment of implementing fault-tolerant TCP splicing.

### DETAILED DESCRIPTION OF THE FIGURES

Existing Transmission Control Protocol (TCP) splice mechanisms are described in U.S. Pat. No. 5,941,988, incorporated herein by reference. Such existing TCP splice mechanisms cannot: (1) distribute a spliced TCP connection through multiple machines, and (2) split the location where TCP splicing is performed between two machines.

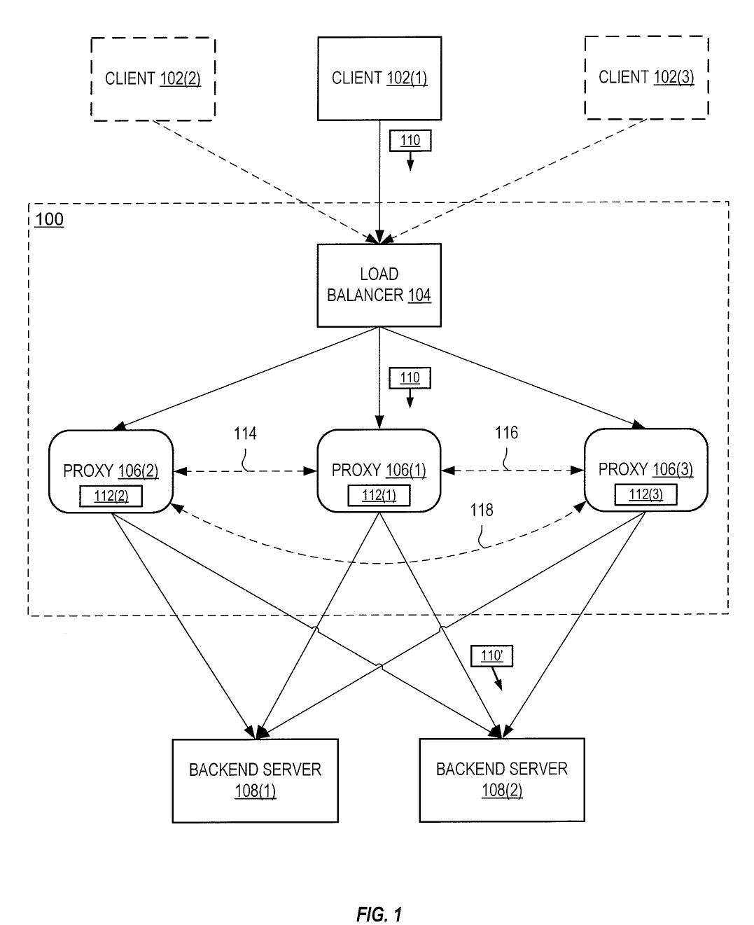

FIG. 1 shows one exemplary system 100 with fault-tolerant TCP splicing that provides communication between one or more clients 102 and one or more backend servers 108. Although three clients 102 are shown in FIG. 1, more or fewer clients 102 may interface with system 100 without departing from the scope hereof. Although two backend servers 108 are shown in FIG. 1, fewer or more backend servers 108 may interface with system 100 without departing from the scope hereof.

System 100 is illustratively shown with a load balancer 104 and three proxies 106. Additional load balancers 104 may be included within system 100 without departing from the scope hereof. More or fewer proxies 106 may be included within system 100 without departing from the scope hereof. Proxies 106 interconnect via communication paths 114, 116 and 118, which for example represent a network connection between proxies 106 to facilitate broadcast and/or multicast communication. Load balancer 104 operates to distribute segments received from clients 102 to one of proxies 106.

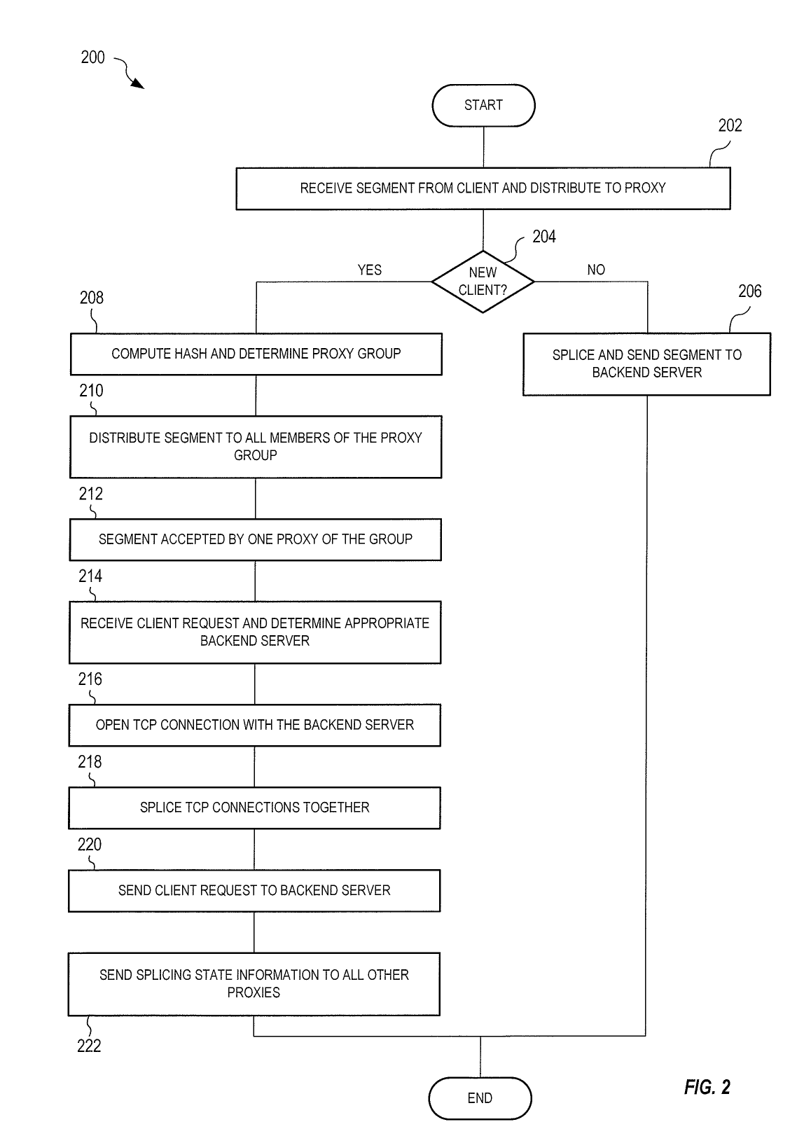

FIG. 2 shows a flowchart illustrating one exemplary method 200 of implementing fault-tolerant TCP splicing. FIG. 1 and FIG. 2 are best viewed together with the following description. Method 200 may operate within system 100.

In one example of operation, in step 202, load balancer 104 receives a segment 110 from client 102(1) and sends segment 110, unmodified, to proxy 106(1). Upon receiving segment 110, proxy 106(1) evaluates its TCP splice state information 112(1) to determine, in step 204, whether the segment is a new client connection.

If segment 110 is for an existing client connection, in step 206, proxy 106(1) modifies the header of segment 110 (i.e., segment 110 is spliced) to form spliced segment 110′ and sends spliced segment 110′ to the appropriate backend server (i.e., backend server 108(2) in this example) as determined from TCP splice state information 112(1).

If the received segment (e.g., segment 110) is a new client connection, in step 208, proxy 106(1) computes a hash value for the connection and a proxy group that is assigned for creating its splices is determined. In step 210, the segment is then multicast (e.g., using communication paths 114, 116, 118) to the members of that proxy group. Upon receiving the segment, in step 212, method 200, within each of the proxies in the proxy group, computes another hash value and, within one member of the proxy group, accepts the segment and the client TCP connection and then waits for the client request to arrive. The client request may comprise one or more TCP segments received via the client TCP connection. Once the client request is received, in step 214, method 200 uses a L7 routing algorithm to select an appropriate (i.e., suitable and/or available for responding to the client request) backend server (e.g., backend server 108) and, in step 216, method 200 opens a TCP connection with the chosen backend server. In step 218, method 200 splices the two TCP connections (i.e., the TCP connection from the client to the proxy and the TCP connection from the proxy to the backend server) and, in step 220, it sends the client request to the backend server. In step 222, the proxy then sends splicing state information of this new TCP splice to all other proxies.

Upon receiving the splicing state information, each proxy updates its TCP splice state information 112 accordingly; thus, further segments from the client arriving on that TCP connection (e.g., ACK segments) are spliced by any proxy 106 to the backend server 108 chosen earlier. Backend server 108, upon receiving the client request, processes the request and sends the response to the client. The server may use any proxy for the response. If split splice is installed on backend server 108, the response may be sent directly to the client without passing through a proxy.

Steps 202-222 repeat as necessary for each TCP segment received from client 102. Although a specific ordering of steps is shown in FIG. 2, steps 202-222 may occur in a different order without departing from the scope hereof.

Operationally, a TCP splice is established at a first proxy for a TCP connection. State information required for splicing each segment of the connection is stored in the OS kernel (e.g., TCP splice state information 112) of the first proxy. The creation of the TCP splice is unlinked with splicing of subsequent segments of the TCP connection by extracting the state information from the OS kernel of the first proxy (i.e., the machine that established the TCP splice) and it is transferred to, and processed by, other proxies such that multiple proxies may subsequently splice segments from the TCP connection. Splitting the splice functionality between two machines uses similar state information transfer and processing.

By allowing TCP splicing over multiple proxies, fault-tolerance and scalability is improved, since the failure of the proxy that created the TCP splice has a negligible affect on the spliced TCP connection; without the foregoing TCP splice enhancements, failure of the proxy that created the TCP splice would result in failure of the TCP connection.

Scalability is also improved because a TCP connection spliced at a first proxy may be distributed among a plurality of proxies; without the foregoing TCP splice enhancements, packets belonging to a connection must pass through the proxy where the connection was spliced.

Scalability of system 100 is further improved by implementing a split-splice mechanism wherein a TCP splice in the return direction is implemented within the backend server and operated to send replies directly to the client from the backend server instead of passing the replies through a proxy. Without this further improvement, return data would be spliced at the original proxy (i.e., the proxy that created the TCP splice), potentially causing that proxy to become a bottleneck. This improvement is particularly significant where responses from the backend server to the client are large.

A system that performs Layer 7 routing may use TCP splice (also called TCP splicing or TCP connection splicing) and may therefore benefit from the above disclosed TCP splice enhancements.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A method for splicing a new TCP connection, comprising:
determining a proxy group for the new TCP connection;
at one of the proxies, accepting the new TCP connection;
receiving, at the one proxy, a client request from a client of the new TCP connection and determining an appropriate backend server to handle the client request;
splicing and sending, at the one proxy, the client request to the appropriate backend server;
sending, from the one proxy, splicing state information of the new TCP connection to other proxies of the proxy group; and
splicing and sending, at any one proxy of the proxy group, each subsequent TCP segment of the new TCP connection to the appropriate backend server.

2. The method of claim 1, the proxy group being determined by computing a first hash value based upon a first TCP segment of the new TCP connection.

3. The method of claim 2, further comprising:
distributing the first TCP segment of the new TCP connection to each proxy of the proxy group; and
determining the one proxy by computing, within each proxy of the proxy group, a second hash value based upon the first TCP segment.

4. The method of claim 1, the client request being formed of one or more TCP segments.

5. The method of claim 1, further comprising:
processing the client request at the appropriate backend server to form a response; and
sending the response to the client.

6. The method of claim 5, the step of sending the response to the client comprising splicing, at the appropriate backend server, the response to the client to bypass the one proxy.

7. A fault-tolerant TCP splice method, comprising:
determining a proxy group for each new TCP connection;
distributing a first TCP segment of the new TCP connection to proxies of the proxy group;
at one of the proxies, accepting the new TCP connection;
receiving a client request at the one proxy and determining an appropriate backend server to receive the client request;
splicing, at the one proxy, the client request to the appropriate backend server;
sending the client request to the appropriate backend server from the one proxy; and
sending splicing state information of the spliced TCP connection to all other proxies of the proxy group.

8. The fault tolerant TCP splice method of claim 7, further comprising receiving, at a load balancer, the TCP segment from a client.

9. The fault tolerant TCP splice method of claim 7, wherein the step of determining comprises determining at a first proxy.

10. The fault tolerant TCP splice method of claim 7, wherein if the TCP segment is not a new TCP connection, further comprising splicing and sending the TCP segment to a backend server associated with an existing TCP connection.

11. The fault tolerant TCP splice method of claim 7, the step of determining the proxy group comprising computing a hash value for the new TCP connection.

12. The fault tolerant TCP splice method of claim 7, the step of distributing the first TCP segment comprising multicasting the first TCP segment to proxies of the proxy group.

13. The fault tolerant TCP splice method of claim 7, further comprising splicing subsequent TCP segments of the new TCP connection at any one proxy of the proxy group and sending the TCP segment to the appropriate backend server from the any one proxy.

14. A fault-tolerant TCP splice method, comprising:
receiving, at a load balancer, a TCP segment from a client;
distributing the TCP segment to a first proxy;
determining, at the first proxy, whether the TCP segment is a new client TCP connection;
splicing and sending the TCP segment to a previously determined backend server if the TCP segment is not a new TCP connection;
if the TCP segment is a new TCP connection:
determining a proxy group for splicing the TCP connection;
distributing the TCP segment to all members of the proxy group;
accepting the TCP connection from the client at one proxy of the proxy group;
receiving a client request at the one proxy and determining an appropriate backend server to receive the client request;
splicing, at the one proxy, the client request to the appropriate backend server;
sending the client request to the appropriate backend server from the one proxy; and
sending splicing state information of the spliced TCP connection to all other proxies of the proxy group.

15. The method of claim 14, the step of sending the client request to the appropriate backend server comprising opening a TCP connection to the appropriate backend server from the one proxy.

16. The method of claim 14, further comprising splicing, at the appropriate backend server, responses from the appropriate backend server to the client to bypass the one proxy.

17. Computer architecture with fault-tolerant TCP splicing, comprising:
at least one backend server;
a proxy group being selected from a plurality of proxies for each new TCP connection, one proxy of the proxy group accepting the new TCP connection and receiving a client request from a client associated with the new TCP connection, the one proxy splicing and sending the client request to an appropriate one of the at least one backend servers, the one proxy sending splicing state information of the new TCP connection to other proxies of the proxy group.

18. The computer architecture of claim 17, wherein subsequent TCP segments of the new TCP connection are spliced and sent to the appropriate one backend server by any one of the proxy group based upon the splicing state information.

19. The computer architecture of claim 17, further comprising at least one load balancer for distributing received TCP segments to the proxies.

20. The computer architecture of claim 17, wherein responses from the appropriate backend server are spliced and sent to the client to bypass the one proxy.
